(19) United States
(12) Patent Application Publication
(10) Pub. No.: US 2025/0365046 A1
(43) Pub. Date: Nov. 27, 2025

(54) SWITCHED-BEAM FIXED WIRELESS ACCESS SYSTEM

(71) Applicant: Airgain, Inc., San Diego, CA (US)

(72) Inventors: Chen-Yuan Chin, San Diego, CA (US); Behrouz Babakhani, San Diego, MN (US); Shenjie Miao, San Diego, CA (US); Ali Sadri, San Diego, CA (US)

(21) Appl. No.: 19/217,181

(22) Filed: May 23, 2025

Related U.S. Application Data
(60) Provisional application No. 63/651,626, filed on May 24, 2024.

(51) Int. Cl. H04B 7/06; H04B 7/0491

(52) U.S. Cl. CPC H04B 7/0617; H04B 7/0491; H04B 7/06958

(57) ABSTRACT

A fixed wireless access (FWA) device includes an antenna system comprising a plurality of sectors situated radially around a central axis of the antenna system. Each sector of the plurality of sectors corresponds to at least one of a single-element antenna and an antenna array of the antenna system. The antenna system is configured to support adjustability of a beam pattern among the plurality of sectors to a plurality of different beam patterns. A processor is communicably coupled to the antenna system. The processor is configured to adjust the beam pattern from a first beam pattern to a second beam pattern different than the first beam pattern.

This application claims the benefit of U.S. Provisional Application No. 63/651,626, filed May 24, 2024, the entire content of which is hereby incorporated by reference.

### SUMMARY

A fixed wireless access (FWA) device comprises an antenna system comprising a plurality of sectors situated radially around a central axis of the antenna system. Each sector of the plurality of sectors corresponds to at least one of a single-element antenna and an antenna array of the antenna system. The antenna system is configured to support adjustability of a beam pattern among the plurality of sectors to a plurality of different beam patterns. A processor is communicably coupled to the antenna system. The processor is configured to adjust the beam pattern from a first beam pattern to a second beam pattern different than the first beam pattern.

A method involves providing an FWA device comprising antenna system comprising a plurality of sectors situated radially around a central axis of the antenna system. Each sector of the plurality of sectors corresponds to at least one of a single-element antenna and an antenna array of the antenna system. The antenna system is configured to support adjustability of a beam pattern among the plurality of sectors to a plurality of different beam patterns. The method includes adjusting the beam pattern from a first beam pattern to a second beam pattern different than the first beam pattern.

An FWA system comprises an antenna system comprising a plurality of sectors situated radially around a central axis of the antenna system. Each sector of the plurality of sectors corresponds to at least one of a single-element antenna and an antenna array of the antenna system. The antenna system is configured to support adjustability of a beam pattern among the plurality of sectors to a plurality of different beam patterns. At least one radio frequency (RF) switch is configured to switch adjust the beam pattern from a first beam pattern to a second beam pattern different than the first beam pattern. A processor is communicably coupled to the antenna system, the processor configured to activate an RF switch of the at least one RF switch to adjust the beam pattern from the first beam pattern to the second beam pattern different than the first beam pattern.

### BRIEF DESCRIPTION OF THE DRAWINGS

Throughout the specification reference is made to the appended drawings wherein:

FIGS. 1A-1C illustrate different beam patterns in used in a communication system where M is equal to four and P is equal to six according to examples described herein;

FIGS. 2A-2D illustrate different side-by side beam patterns in used in a communication system where M is equal to four and P is equal to four according to examples described herein;

FIGS. 3A and 3B illustrate different back-to-back beam patterns in used in a communication system where M is equal to four and P is equal to four according to examples described herein;

FIGS. 4A-4D illustrate different all-in-one beam patterns in used in a communication system where M is equal to four and P is equal to four according to examples described herein;

FIG. 5 depicts a generalized block diagram for a switched-beam FWA supporting an M-by-N MIMO with P sectors in accordance with examples described herein;

FIG. 6 shows an example of an FWA system in accordance with examples described herein;

FIG. 7 illustrates a beam configuration for the example FWA system of FIG. 6 in accordance with examples described herein;

FIG. 8 shows another example of an FWA system in accordance with examples described herein;

FIG. 9 illustrates a beam configuration for the example FWA system of FIG. 8 in accordance with examples described herein;

FIGS. 10A and DB show performance results between a traditional FWA system and a switched-beam FWA system in accordance with examples described herein; and

FIG. 11 illustrates a method of controlling an FWA system in accordance with examples described herein; and

FIG. 12 illustrates a block diagram of a system and apparatus configured to perform the methods described herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Fixed Wireless Access (FWA) is a type of wireless communication that provides internet access to fixed locations or premises. Examples described herein involve a smart FWA system that utilizes beam-switching technology to create multiple simultaneous beams to enhance the FWA performance against the traditional fixed-beam FWA, especially at the bands with wide-bandwidth, e.g., n41, n78.

Embodiments of the disclosure are defined in the claims. However, below there is provided a non-exhaustive listing of non-limiting examples. Any one or more of the features of these examples may be combined with any one or more features of another example, embodiment, or aspect described herein.
Example Ex1. An apparatus, comprising:
a fixed wireless access (FWA) device comprising:
an antenna system comprising a plurality of sectors situated radially around a central axis of the antenna system, each sector of the plurality of sectors corresponding to at least one of a single-element antenna and an antenna array of the antenna system, the antenna system configured to support adjustability of a beam pattern among the plurality of sectors to a plurality of different beam patterns; and
a processor communicably coupled to the antenna system, the processor configured to adjust the beam pattern from a first beam pattern to a second beam pattern different than the first beam pattern.
Example Ex2 The apparatus of Ex1, wherein the FWA device comprises at least one radio frequency (RF) switch configured to switch adjust the beam pattern from the first beam pattern to the second beam pattern.
Example Ex3. The apparatus of Ex1, wherein the antenna system comprises a plurality of antennas configured to operate at a plurality of respective frequency bands, the fixed wireless access device further comprising a port mapping matrix configured to combine the plurality of frequency bands.
Example Ex4. The apparatus of Ex3, wherein the port mapping matrix comprises at least one multiplexer configured to combine the plurality of frequency bands.
Example Ex5. The apparatus of Ex4, wherein the multiplexer is configured to separate the plurality of frequency bands at an output of the multiplexer.
Example Ex6. The apparatus of Ex3, wherein at least one of the frequency bands of the plurality of frequency bands is a switched frequency band and at least another frequency band of the plurality of frequency bands is a fixed frequency band.
Example Ex7. The apparatus of Ex1, wherein the beam pattern is an antenna pattern from one sector and each beam pattern can support a plurality of frequency bands.
Example Ex8. The apparatus of Ex1, wherein the processor is configured to select a portion of the plurality of beams to activate based on a signal performance indicator.
Example Ex9. The apparatus of Ex8, wherein the processor is configured to activate only the portion of the plurality of beams simultaneously.
Example Ex10. The apparatus of Ex1, wherein the antenna system is configured to produce a plurality of beam configurations.
Example Ex11. The apparatus of Ex10, wherein plurality of beam configurations comprise side-by-side, back-to-back, and all-in-one.
Example Ex12. The apparatus of Ex 10, wherein the processor is configured to determine a preferred beam configuration of the plurality of beam configurations.
Example Ex13. The apparatus of Ex1, wherein the fixed wireless access device supports a multiple input multiple output (MIMO) device.
Example Ex14. A method, comprising:
   providing a fixed wireless access (FWA) device comprising antenna system comprising a plurality of sectors situated radially around a central axis of the antenna system, each sector of the plurality of sectors corresponding to at least one of a single-element antenna and an antenna array of the antenna system, the antenna system configured to support adjustability of a beam pattern among the plurality of sectors to a plurality of different beam patterns; and
   adjusting the beam pattern from a first beam pattern to a second beam pattern different than the first beam pattern.
Example Ex15. The method of Ex14, further comprising selecting a portion of the plurality of beams to activate based on a signal performance indicator.
Example Ex16. The method of Ex15, further comprising activating only the portion of the plurality of beams simultaneously.
Example Ex17. The method of Ex14, wherein the antenna system is configured to produce a plurality of beam configurations.
Example Ex18. The method of Ex17, wherein plurality of beam configurations comprise side-by-side, back-to-back, and all-in-one.
Example Ex19. The method of Ex17, further comprising determining a preferred beam configuration of the plurality of beam configurations based on a signal performance indicator.
Example Ex20. A fixed wireless access system, comprising:
   an antenna system comprising a plurality of sectors situated radially around a central axis of the antenna system, each sector of the plurality of sectors corresponding to an antenna array of the antenna system, the antenna array comprising a plurality of antennas configured to operate at a plurality of respective frequency bands, the antenna system configured to support adjustability of a beam pattern among the plurality of sectors to a plurality of different beam patterns;
   at least one radio frequency (RF) switch configured to switch adjust the beam pattern from a first beam pattern to a second beam pattern different than the first beam pattern; and
   a processor communicably coupled to the antenna system, the processor configured to activate an RF switch of the at least one RF switch to adjust the beam pattern from the first beam pattern to the second beam pattern different than the first beam pattern.

According to various examples described herein an FWA, for example a 5G FWA, supports an M by N multiple-input multiple output (MIMO) system and has P sectors. M is an integer and represents a number of downlink streams. In this example, M is greater than or equal to two and is even. N is an integer and represents the number of uplink streams. N is greater than or equal to two and is even. According to various examples, M is greater than or equal to N. P is an integer and represents the number of sectors. P is greater than or equal to two.

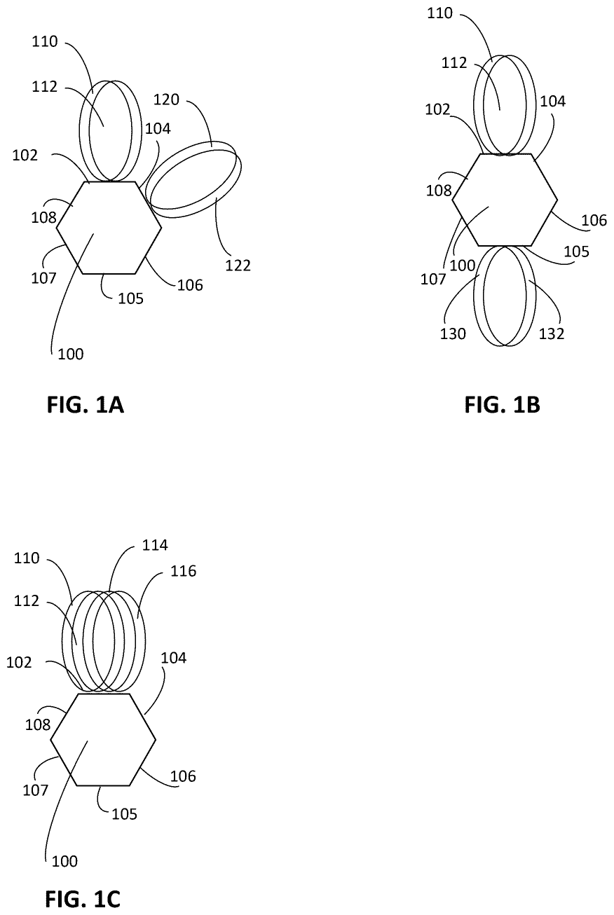

FIGS. 1A-1C illustrate different beam patterns in used in a communication system where M is equal to four and P is equal to six sectors 102, 104, 105, 106, 107, 108 according to examples described herein. FIG. 1A illustrates a side-by side beam pattern. In this example, beams 110, 112, 120, 122 on two adjacent sectors 105, 107 of the antenna 100. This example and other examples described herein show two or four beams formed at the activated sectors, but it is to be understood that more or fewer beams may be formed at each sector. In some examples, a different number of beams are formed on one sector than are formed on another sector. FIG. 1B shows a back-to-back beam pattern. In this example the beams 110, 112, 130, 132 are formed on opposite sectors 102, 105 of the antenna 100. In this example, P must be an even number so that the beams can be formed on opposite sectors. FIG. 1C illustrates an all-in-one beam pattern. In this example, all of the four beams 110, 112, 114, 116 are formed at the same sector 105 of the antenna 100.

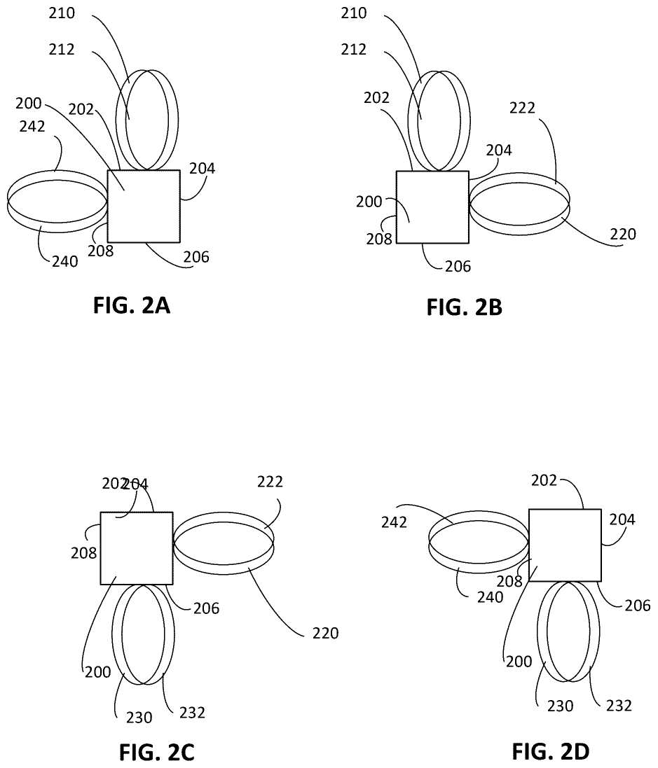

FIGS. 2A-2D illustrate different side-by side beam patterns in used in a communication system where M is equal to four and P is equal to four according to examples described herein. In this example, M/2 beams are located at one sector while the other M/2 beams are located at the neighboring sector. Due to the rotational symmetry, there are P states in this configuration.

FIG. 2A illustrates an antenna 200 having a side-by-side beam patterns where beams 210, 212, 240, 242 are formed at adjacent sectors 202, 208. FIG. 2B illustrates an antenna 200 having a side-by-side beam patterns where beams 210, 212, 220, 222 are formed at adjacent sectors 202, 204. FIG. 2C illustrates an antenna 200 having a side-by-side beam patterns where beams 220, 222, 230, 232 are formed at adjacent sectors 204, 206. FIG. 2D illustrates an antenna 200 having a side-by-side beam patterns where beams 230, 232, 240, 242 are formed at adjacent sectors 206, 208.

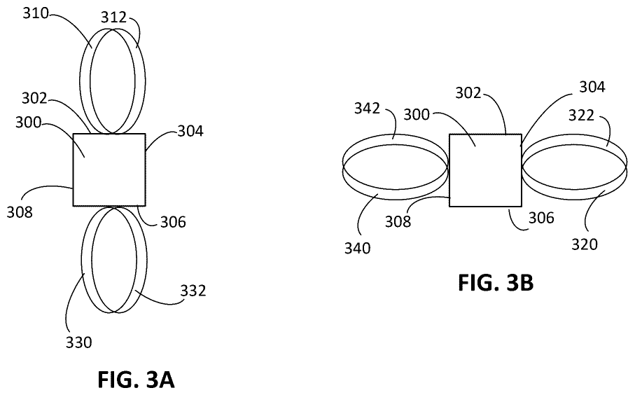

FIGS. 3A and 3B illustrate different back-to-back beam patterns in used in a communication system where M is equal to four and P is equal to four according to examples described herein. In this example, M/2 beams are located at one sector and the other M/2 beams are located at the opposite sector. Due to the rotational symmetry, there are P/2 states in this configuration.

FIG. 3A illustrates an antenna 300 having a back-to-back beam patterns where beams 310, 312, 330, 332 are formed at opposite sectors 302, 306. FIG. 3B illustrates an antenna 300 having a back-to-back beam patterns where beams 320, 322, 340, 342 are formed at opposite sectors 304, 308.

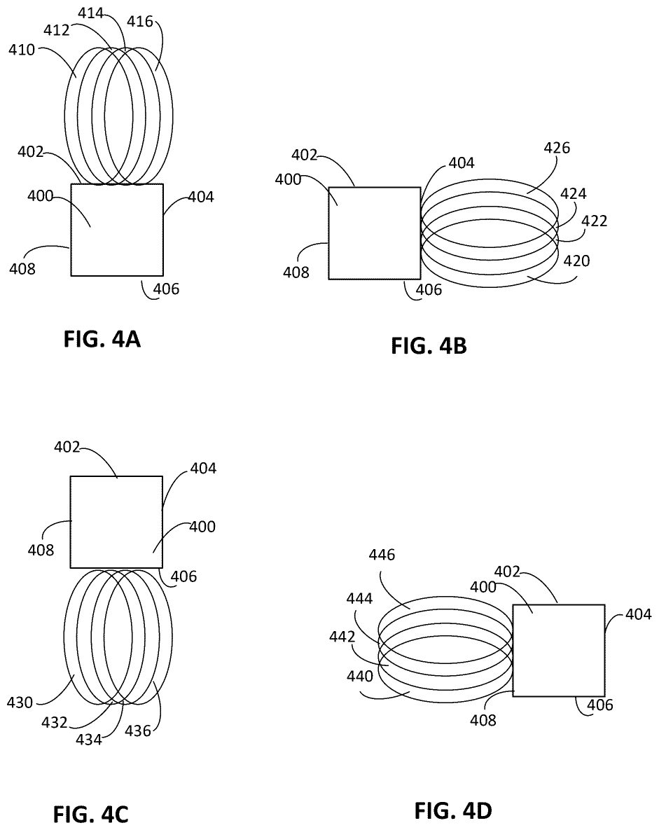

FIGS. 4A-4D illustrate different all-in-one beam patterns in used in a communication system where M is equal to four and P is equal to four according to examples described herein. In this example, all M beams are located at the same sector. Due to the rotational symmetry, there are P states in this configuration.

FIG. 4A illustrates an antenna 400 having an all-in-one beam pattern where beams 410, 412, 414, 416 are formed at the same first sector 402. FIG. 4B illustrates an antenna 400 having an all-in-one beam configuration where beams 420, 422, 424, 426 are formed at the same second sector 404. FIG. 4C illustrates an antenna 400 having an all-in-one beam pattern where beams 430, 432, 434, 436 are formed at the same third sector 406. FIG. 4D illustrates an antenna 400 having an all-in-one beam configuration where beams 440, 442, 444, 446 are formed at the same fourth sector 408.

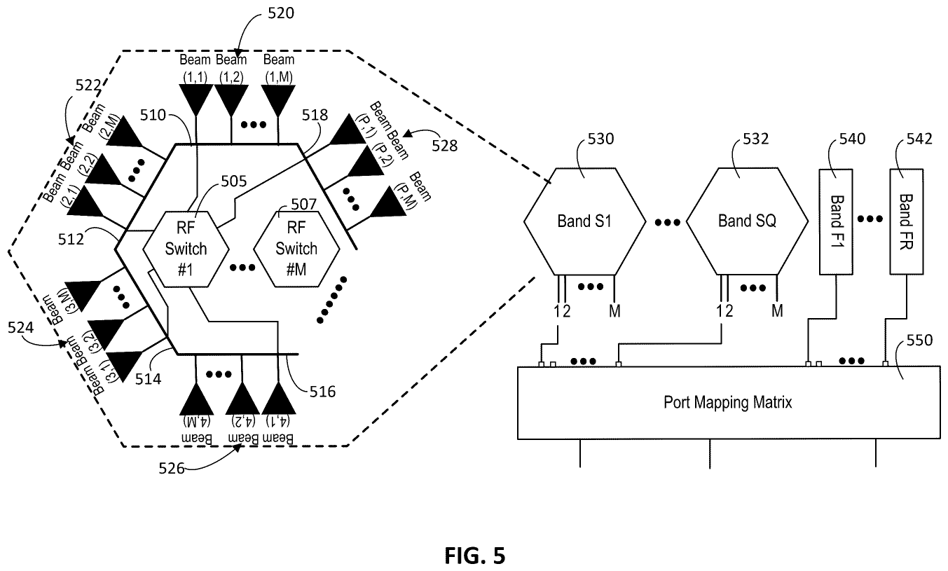

FIG. 5 depicts a generalized block diagram for a switched-beam FWA supporting an M-by-N MIMO with P sectors 510, 512, 514, 516, 518 in accordance with examples described herein. In this example, an antenna system includes a plurality of antennas that are configured to operate at a plurality of respective antenna bands. Each antenna band may be a switched beam band or a fixed beam band. In a switched beam band, the beams are fixed in a particular direction. In a switched beam band, the beams are able to be switched to face in different directions as described above. In this example, there are Q bands using the switched beam (band S1 530 through band SQ 532) and R bands (band F1 540 through band FR 542) using the fixed beam. When Q=0, it becomes a traditional FWA (fixed beam only), and when R=0, the system is a pure sectorized smart FWA (switched beam only). A hybrid combination includes some fixed beams and some switched beams. As the number of switched beams increases, the cost and complexity also generally increases. A port mapping matrix 550 combines multiple frequency bands. For example, the port mapping matrix 550 combines the switched beam bands 530, 532 and the fixed beam bands 540, 542. The port mapping matrix may include direct cable connections and RF multiplexers. The port mapping matrix may include one or both of a multiplexer and a diplexer. The multiplexer or the diplexer is configured to separate the frequency bands at an output of the multiplexer.

Each sector may have an equal number of respective possible beams (M) 520, 522, 524, 526, 528. Each beam may correspond to a different number of antennas. An antenna could be one single antenna element or an antenna array that includes multiple antenna elements. For the antenna array, the number of antenna elements is not fixed. In an example, to change a beam shape and/or beam direction from a first state to a second state, an antenna array is used with a different number or configuration of antennas than what was used for the first state. Out of the M possible beams M′ beams may be activated where M′ is greater than or equal to M. Each switched beam band includes M radio frequency (RF) switches 505, 507 that are configured to switch a beam pattern of the beams 520, 522, 524, 526, 528 among the sectors 510, 512, 514, 516, 518.

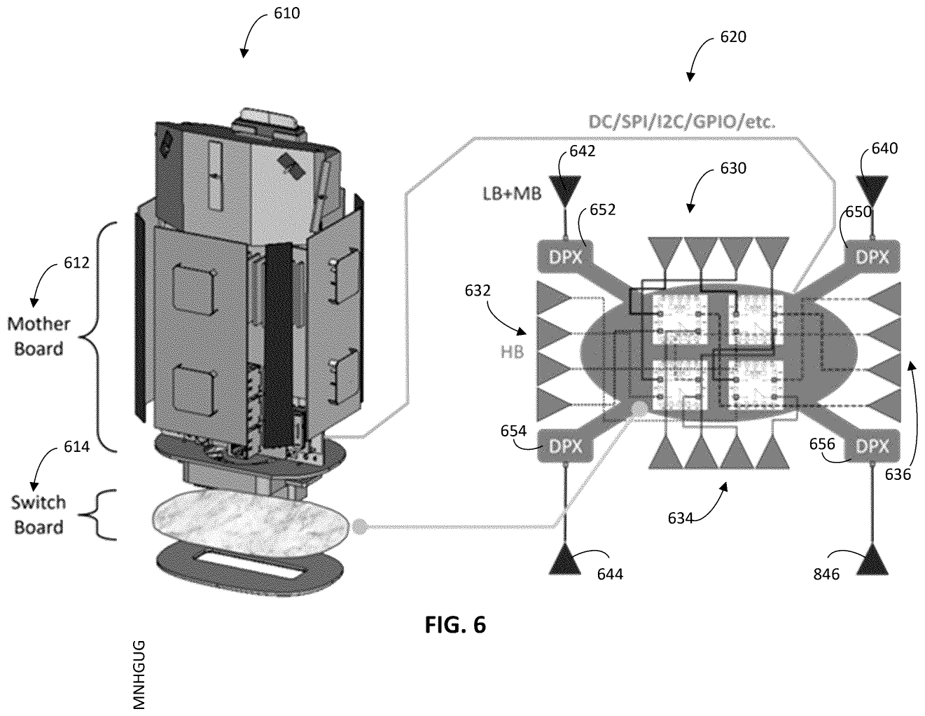

FIG. 6 shows an example of an FWA system 610 in accordance with examples described herein. The FWA includes a mother board 612, an antenna system 620, and a switch board 614. This example FWA system has the following parameters.
Supported configurations: side-by-side, back-to-back, and all-in-one

$$M = N = 4 ( 4 X4 MIMO )$$

$${M}^{′} = 4$$

$$\# Beam / sector = 4$$

$$\# Antenna / sector = 4$$

$$P = 4$$

$$Q = 1$$

$$Band S 1 = 3300 - 3800 MHz$$

$$R = 4$$

$$Band F 1 = Band F 2 = Band F 3 = Band F 4 = 617 - 960 / 1710 - 2690 MHz$$

$$Switch \#1 = Switch \#2 = Switch \#3 = Switch \#4 = SP 4 T$$

$$Port Mapping Matrix = 4 * Diplexer ( DPX )$$

The detailed view of the antenna system 620 illustrates possible beam positions from the switched beam antennas 630, 632, 634, 636 among the four sectors. The flexible beam configuration is achieved by giving four degrees of freedom to each beam using single-pole-four-throw (SP4T) switches. Fixed beam antennas 640, 642, 644, 646 operate at a low and/or mid-range frequency and the switched beam antennas 630, 632, 634, 636 operate at a high band frequency. In this example, switched beam antennas 630, 632, 634, 636 operate at band S1 (for example, 3300 to 3800 MHZ). In some examples, at least one of the switched beam antennas 630, 632, 634, 636 operates at a different frequency band than at least one other of the switched beam band antennas 630, 632, 634, 636. The fixed beam band antennas 640, 642, 644, 646 operate at band F1. According to some examples, band F1 is a combination of low band and mid-band frequencies or may be one of a low frequency band or a high frequency band. For example, as indicated above, the low frequency band is 617 to 690 MHz and the mid-frequency band is 1710 to 2690 MHz. While FIG. 6 illustrates the fixed beam bands being low frequency or mid-frequency bands and the switched beam bands being a high frequency band, it is to be understood that different band configurations may be used. For example, the switched beam bands may be mid-frequency and the fixed beam bands may be low frequency or high frequency, etc. This example uses four diplexers 650, 652, 654, 656 to combine the fixed beam bands and the switched beam bands.

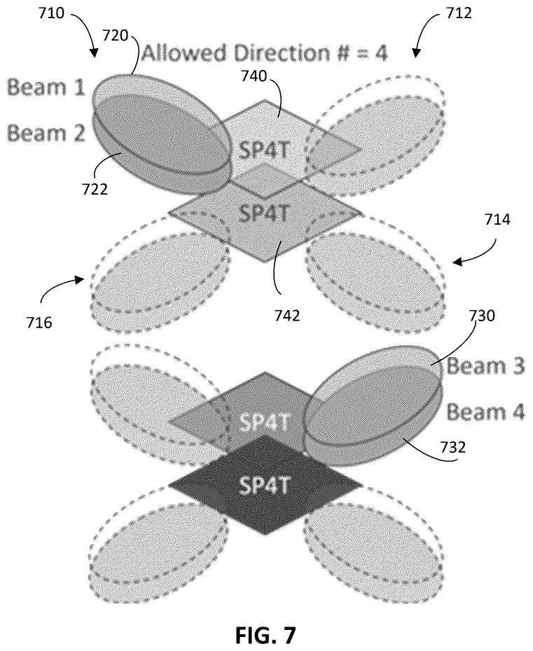

FIG. 7 illustrates a beam configuration for the example FWA system of FIG. 6 in accordance with examples described herein. As described in FIG. 6, the beams have four degrees of freedom between the four different sectors 710, 712, 714, 716. Specifically, beam 1 720, beam 2 722, beam 3 730, and beam 4 732 can switch between any of a first sector 710, a second sector 712, a third sector 714, and a fourth sector 716 via switches 740, 742. While this example shows beam 1 720 and beam 2 722 in a side-by-side configuration with beam 3 730 and beam 4 732. The beams may be activated in the back-to-back or the all-in one configurations in this example.

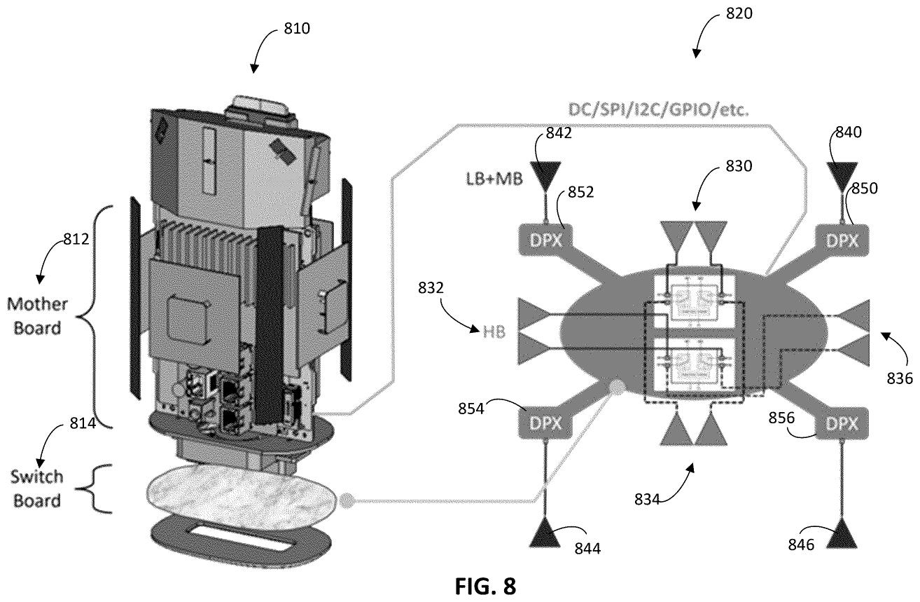

FIG. 8 shows another example of an FWA system 810 in accordance with examples described herein. The FWA includes a mother board 812, an antenna system 820, and a switch board 814. This example FWA system has the following parameters.
Supported configuration: side-by-side

$$M = N = 4 ( 4 X4 MIMO )$$

$${M}^{′} = 2$$

$$\# Beam / sector = 2$$

$$\# Antenna / sector = 2$$

$$P = 4$$

$$Q = 1$$

$$Band S 1 = 3300 - 3800 MHz$$

$$R = 4$$

$$Band F 1 = Band F 2 = Band F 3 = Band F 4 = 617 - 960 / 1710 - 2690 MHz$$

$$Switch \#1 = Switch \#2 = Switch \#3 = Switch \#4 = SP 2 T$$

$$Port Mapping Matrix = 4 * Diplexer ( DPX )$$

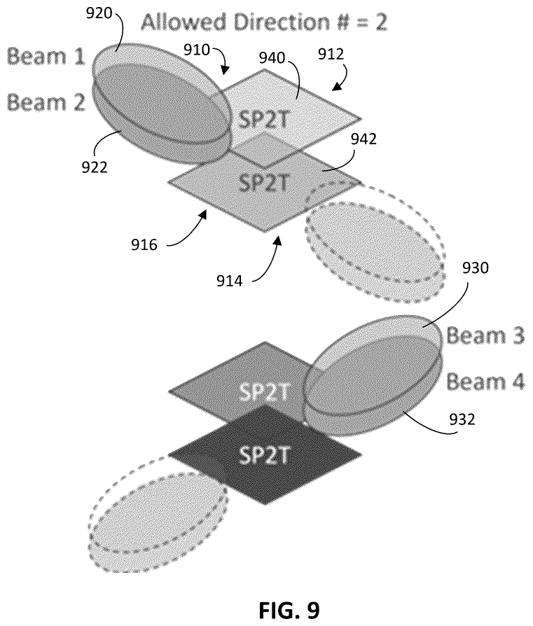

The detailed view of the antenna system 820 illustrates possible beam positions from the switched beam antennas 830, 832, 834, 836 among the four sectors. In this example, only side-by side configuration is supported so the number of antennas per sector is reduced and the switching degree of freedom of each beam is limited as shown in more detail in FIG. 9. In contrast to the example shown in FIG. 6, there are two beams per sector instead of four beams per sector. The flexible beam configuration is achieved by giving two degrees of freedom to each beam using single-pole-two-throw (SP2T) switches. Fixed beam antennas 840, 842, 844, 846 operate at a low and/or mid-range frequency and the switched beam antennas 830, 832, 834, 836 operate at a high band frequency. In this example, switched beam antennas 830, 832, 834, 836 operate at band S1 (for example, 3300 to 3800 MHZ). In some examples, at least one of the switched beam antennas 830, 832, 834, 836 operates at a different frequency band than at least one other of the switched beam band antennas 830, 832, 834, 836. The fixed beam band antennas 840, 842, 844, 846 operate at band F1. According to some examples, band F1 is a combination of low band and mid-band frequencies or may be one of a low frequency band or a high frequency band. For example, as indicated above, the low frequency band is 617 to 690 MHz and the mid-frequency band is 1710 to 2690 MHz. While FIG. 8 illustrates the fixed beam bands being low frequency or mid-frequency bands and the switched beam bands being a high frequency band, it is to be understood that different band configurations may be used. For example, the switched beam bands may be mid-frequency and the fixed beam bands may be low frequency or high frequency, etc. This example uses four diplexers 850, 852, 654, 856 to combine the fixed beam bands and the switched beam bands.

FIG. 9 illustrates a beam configuration for the example FWA system of FIG. 8 in accordance with examples described herein. In this example, each beam has two degrees of freedom to switch. Beam 1 920 and beam 2 922 can switch between a first sector 910 and a third sector 914 while beam 3 930 and beam 4 932 can switch between a second sector 912 and a fourth sector 916 via switches 940, 942.

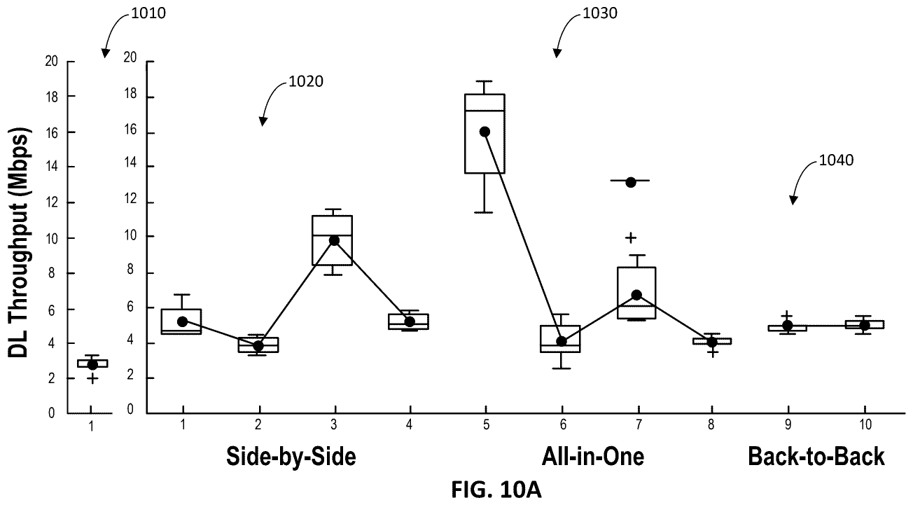

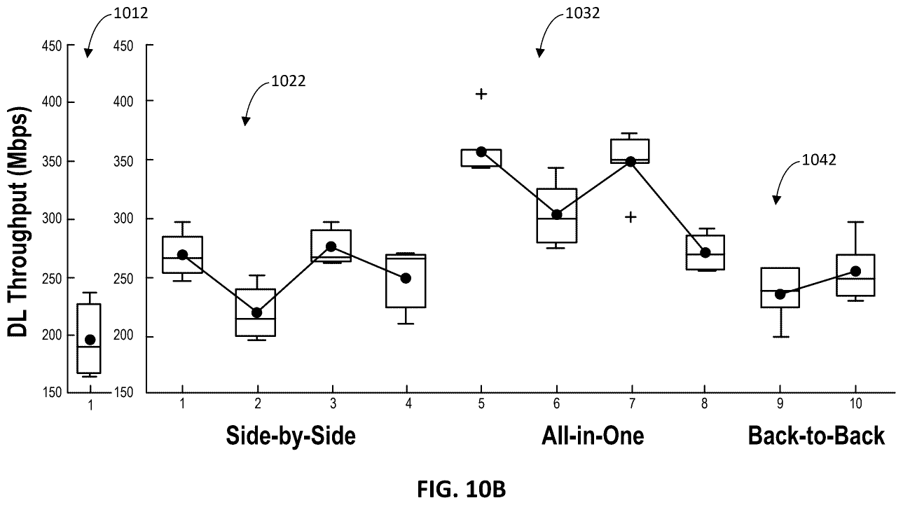

FIGS. 10A and DB show performance results between a traditional FWA system and a switched-beam FWA system in accordance with examples described herein. FIG. 10A shows the uplink throughput results for a fixed beam traditional FWA system 1010, a side-by-side switched-beam FWA system 1020, an all-in-one switched-beam FWA system 1030, and a back-to-back switched-beam FWA system 1040. Similarly, FIG. 10B illustrates downlink throughput results for a fixed beam traditional FWA system 1012, a side-by-side switched-beam FWA system 1022, an all-in-one switched-beam FWA system 1032, and a back-to-back switched-beam FWA system 1042.

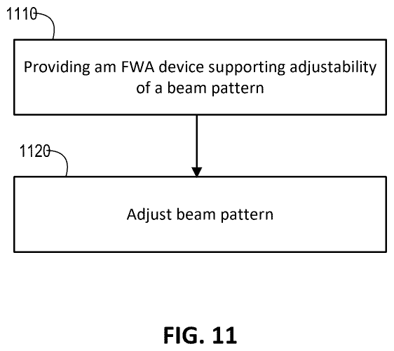

FIG. 11 illustrates a method of controlling an FWA system in accordance with examples described herein. A fixed wireless access (FWA) device comprising antenna system comprising a plurality of sectors situated radially around a central axis of the antenna system is provided 1110. Each sector of the plurality of sectors corresponding to at least one of a single-element antenna and an antenna array of the antenna system, the antenna system configured to support adjustability of a beam pattern among the plurality of sectors to a plurality of different beam patterns. The beam pattern is adjusted 1120 from a first beam pattern to a second beam pattern different than the first beam pattern.

According to various examples, the beam patterns are selected based on a performance metric. The beam pattern selection may include a selection of a specified portion of the beams or a selection of a particular beam pattern or configuration. For example, the beam patterns may be selected based on a signal performance metric or indicator that may be associated with a preferred beam configuration. For example, if signal performance drops below a certain threshold the beam patterns may be selected than are known to increase signal performance. This may include activating more beams and/or selecting a different beam pattern. In some examples, signal performance is not directly measured, but may inferred based on historical data, weather data, time of day, or time of year or any combination thereof. The preferred beam configuration may be selected using an embedded artificial intelligence model using a machine learning process.

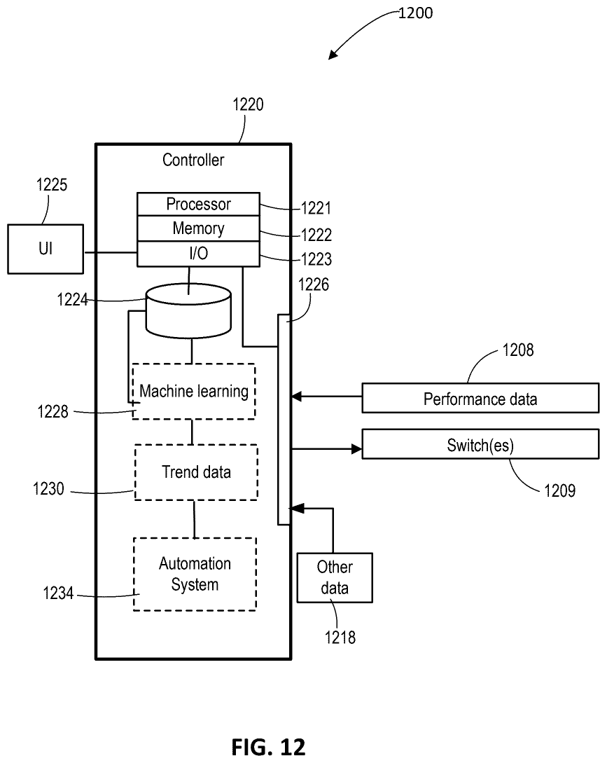

The methods and processes described above can be implemented on computer hardware, for example, workstations, servers. In FIG. 12, a block diagram shows a system and computing apparatus 1200 that may be used to implement methods according to various examples (for example, as a computer, a mobile device, a server, a smart sensor, a control system, among others.). The components may be implemented as integrated circuits (ICs), portions thereof, discrete electronic devices, or other modules, instruction sets, programmable logic or algorithms, hardware, hardware accelerators, software, firmware, or a combination thereof, or as components otherwise incorporated within a chassis of a larger system.

The controller 1220 may include conventional computing hardware such as a central processor 1221, memory 1222, input/output (I/O) interfaces 1223, and a non-volatile data storage unit 1224 (for example, hard disk drives, solid state drives). The processor 1221 may include any one or more of a microprocessor, a controller, a digital signal processor (DSP), an application specific integrated circuit (ASIC), a field-programmable gate array (FPGA), and/or equivalent discrete or integrated logic circuitry. In some examples, the processor 1221 may include multiple components, such as any combination of one or more microprocessors, one or more controllers, one or more DSPs, one or more ASICs, and/or one or more FPGAs, as well as other discrete or integrated logic circuitry. The functions attributed to the controller 1220 and/or processor 1221 herein may be embodied as software, firmware, hardware, or any combination thereof. Certain functionality of the controller 1220 may also be performed in the cloud or other distributed computing systems operably connected to the processor 1221. It is to be understood that the computing devices described herein may be a set of computing devices that are communicatively coupled via a cloud-based system, for example. For example, controller 1220 can be a system of multiple controllers that operate together in a cloud-based system.

The memory 1222 may include any volatile, non-volatile, magnetic, optical, and/or electrical media, such as a random-access memory (RAM), read-only memory (ROM), non-volatile RAM (NVRAM), electrically erasable programmable ROM (EEPROM), flash memory, and/or any other digital media. While shown as both being incorporated into the controller 1220, the memory 1222 and the processor 1221 could be contained in separate modules.

The controller 1220 includes an external data interface 1226 that may receive performance data 1208, for example. The controller 1220 uses the performance data 1208 to control activation of the beams, for example. The performance data may be signal performance data. In response the signal performance dropping below a predefined threshold, the controller 1220 may send an activation signal to one or more switches 1209. In some examples, signal performance data is not used to change the beam pattern and the controller changes the beam pattern automatically based on a different triggering event. For example, the controller may activate a different beam pattern depending on a time of day, time of year, and a weather pattern, for example. Other sources of data 1218 may also be used as inputs to the controller 1220, such as ambient temperatures or other weather data, for example.

According to various examples, signal performance data and/or a current beam pattern may be accessed via a user interface 1225 that communicates data to a user. The user may be able to manually activate a beam pattern via the user interface 1225.

The data storage unit 1224 may store a machine learning model 1228 that predicts various information about signal performance based on historical and present user input data. According to various examples, a trend data model 1230 may be used to trend past data pertaining to signal performance and beam patterns with or without input from the machine learning model 1228. An automation system 1234 is used to perform one or more automatic actions such as automatic activation of a particular beam pattern, for example.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed embodiments may be practiced other than as explicitly described herein.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “various embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” The term “and/or” means one or all of the listed elements or a combination of at least two of the listed elements. The phrases “at least one of,” “comprises at least one of,” and “one or more of” followed by a list refers to any one of the items in the list and any combination of two or more items in the list.

What is claimed is:

1. An apparatus, comprising:
a fixed wireless access (FWA) device comprising:
an antenna system comprising a plurality of sectors situated radially around a central axis of the antenna system, each sector of the plurality of sectors corresponding to at least one of a single-element antenna and an antenna array of the antenna system, the antenna system configured to support adjustability of a beam pattern among the plurality of sectors to a plurality of different beam patterns; and
a processor communicably coupled to the antenna system, the processor configured to adjust the beam pattern from a first beam pattern to a second beam pattern different than the first beam pattern.

2. The apparatus of claim 1, wherein the FWA device comprises at least one radio frequency (RF) switch configured to switch adjust the beam pattern from the first beam pattern to the second beam pattern.

3. The apparatus of claim 1, wherein the antenna system comprises a plurality of antennas configured to operate at a plurality of respective frequency bands, the fixed wireless access device further comprising a port mapping matrix configured to combine the plurality of frequency bands.

4. The apparatus of claim 3, wherein the port mapping matrix comprises at least one multiplexer configured to combine the plurality of frequency bands.

5. The apparatus of claim 4, wherein the multiplexer is configured to separate the plurality of frequency bands at an output of the multiplexer.

6. The apparatus of claim 3, wherein at least one of the frequency bands of the plurality of frequency bands is a switched frequency band and at least another frequency band of the plurality of frequency bands is a fixed frequency band.

7. The apparatus of claim 1, wherein the beam pattern is an antenna pattern from one sector and each beam pattern can support a plurality of frequency bands.

8. The apparatus of claim 1, wherein the processor is configured to select a portion of the plurality of beams to activate based on a signal performance indicator.

9. The apparatus of claim 8, wherein the processor is configured to activate only the portion of the plurality of beams simultaneously.

10. The apparatus of claim 1, wherein the antenna system is configured to produce a plurality of beam configurations.

11. The apparatus of claim 10, wherein plurality of beam configurations comprise side-by-side, back-to-back, and all-in-one.

12. The apparatus of claim 10, wherein the processor is configured to determine a preferred beam configuration of the plurality of beam configurations.

13. The apparatus of claim 1, wherein the fixed wireless access device supports a multiple input multiple output (MIMO) device.

14. A method, comprising:
providing a fixed wireless access (FWA) device comprising antenna system comprising a plurality of sectors situated radially around a central axis of the antenna system, each sector of the plurality of sectors corresponding to at least one of a single-element antenna and an antenna array of the antenna system, the antenna system configured to support adjustability of a beam pattern among the plurality of sectors to a plurality of different beam patterns; and
adjusting the beam pattern from a first beam pattern to a second beam pattern different than the first beam pattern.

15. The method of claim 14, further comprising selecting a portion of the plurality of beams to activate based on a signal performance indicator.

16. The method of claim 15, further comprising activating only the portion of the plurality of beams simultaneously.

17. The method of claim 14, wherein the antenna system is configured to produce a plurality of beam configurations.

18. The method of claim 17, wherein plurality of beam configurations comprise side-by-side, back-to-back, and all-in-one.

19. The method of claim 17, further comprising determining a preferred beam configuration of the plurality of beam configurations based on a signal performance indicator.

20. A fixed wireless access system, comprising:
an antenna system comprising a plurality of sectors situated radially around a central axis of the antenna system, each sector of the plurality of sectors corresponding to an antenna array of the antenna system, the antenna array comprising a plurality of antennas configured to operate at a plurality of respective frequency bands, the antenna system configured to support adjustability of a beam pattern among the plurality of sectors to a plurality of different beam patterns;
at least one radio frequency (RF) switch configured to switch adjust the beam pattern from a first beam pattern to a second beam pattern different than the first beam pattern; and
a processor communicably coupled to the antenna system, the processor configured to activate an RF switch of the at least one RF switch to adjust the beam pattern from the first beam pattern to the second beam pattern different than the first beam pattern.
